(19) United States
(12) Patent Application Publication
(10) Pub. No.: US 2016/0214490 A1
(43) Pub. Date: Jul. 28, 2016

(54) POWER GENERATION MODE OPTIMIZATION

(71) Applicant: FORD GLOBAL TECHNOLOGIES, LLC, Dearborn, MI (US)

(72) Inventors: BRIAN THOMAS SOO, West Bloomfield, MI (US); WALTER JOSEPH ORTMANN, Saline, MI (US); MARVIN PAUL KRASKA, Dearborn, MI (US); MICHAEL D. WALLACE, Chesterfield, MI (US)

(21) Appl. No.: 14/607,323

(22) Filed: Jan. 28, 2015

(51) Int. Cl. B60L 11/18; B60L 7/10

(52) U.S. Cl. CPC B60L 11/1809; B60L 11/1861; B60L 7/10; Y10S 903/907

(57) ABSTRACT

A vehicle including a powertrain having an electric machine, an engine, a traction battery, and a controller are provided. The controller may be programmed to, in response to a state of charge of the traction battery being less than a threshold while the traction battery is powering a device external to the vehicle, operate the powertrain to charge the traction battery at a rate based on an ambient temperature irrespective of an electric load requested by the device.

### TECHNICAL FIELD

The present disclosure relates to systems and methods for optimizing engine performance.

### BACKGROUND

A hybrid electric vehicle may include a powertrain having an engine and a motor-generator operatively connected to a battery. The battery may be configured to provide power used to propel the vehicle and provide power not used to propel the vehicle. The power that is not used to propel the vehicle may be supplied to external equipment such as saws, drills, or other power tools. The engine, motor-generator, and/or battery may be operated as power is supplied to the external equipment. The engine and motor-generator may cycle on and off based on the amount of power requested by the external equipment.

### SUMMARY

A vehicle may include a powertrain having an electric machine, an engine, a traction battery, and a controller. The controller may be programmed to, in response to a state of charge of the traction battery being less than a threshold while the traction battery is powering a device external to the vehicle, operate the powertrain to charge the traction battery at a rate based on an ambient temperature irrespective of an electric load requested by the device.

A vehicle may include an engine, a traction battery, and a controller. The controller may be programmed to, in response to a state of charge of the traction battery approaching a lower threshold while the traction battery is powering a device external to the vehicle, operate the engine to charge the traction battery at a predetermined power level that is based on a fuel consumption rate and speed of the engine.

A method of controlling a vehicle may include, in response to a state of charge of a traction battery approaching a lower threshold while the traction battery provides power to an off-board auxiliary device, operating an engine and an electric machine to charge the traction battery at a rate based on the state of charge, a speed of the electric machine, and a temperature of the traction battery.

### BRIEF DESCRIPTION OF THE DRAWINGS

FIG. 1 a schematic diagram of a hybrid electric vehicle.

FIGS. 2A-2C are time plots showing an exemplary system response.

FIG. 3 is a flow chart of an exemplary algorithm for controlling a vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

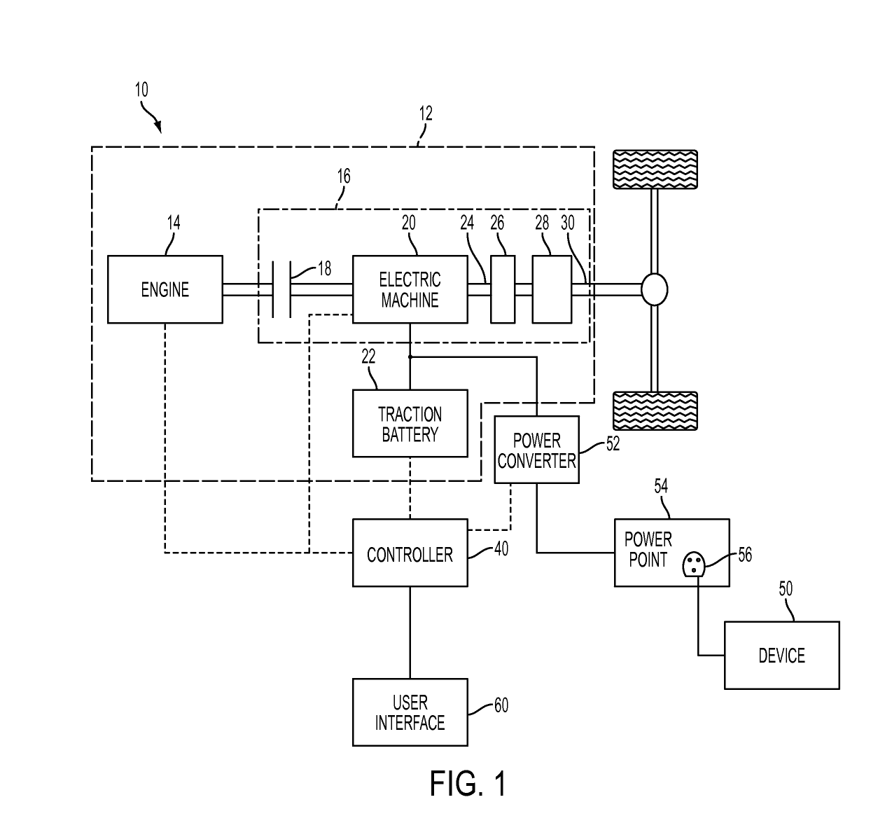

Referring to FIG. 1, a schematic diagram of a vehicle 10 is illustrated according to an exemplary embodiment of the present disclosure. Physical placement and orientation of the components within the vehicle 10 may vary. Although the vehicle of FIG. 1 will be particularly described, the strategies in accordance with embodiments of the present disclosure may apply to other vehicle configurations.

The vehicle 10 may include a powertrain 12 having an engine 14 that is selectively connected to a transmission 16. The transmission 16 may include a disconnect clutch 18, an electric machine 20 such as an electric motor-generator, an associated traction battery 22, an input shaft 24, a torque converter 26, a gear box 28, and an output shaft 30.

The engine 14 may be selectively mechanically coupled to the electric machine 20 and the remainder of the transmission 16 by the disconnect clutch 18. The engine 14 and the electric machine 20 may both act as drive sources for the vehicle 10 by providing torque to the gearbox 28 via an input shaft 24. The electric machine 20 may be implemented by any one of a plurality of types of electric machines, such as a permanent magnet synchronous motor.

The torque converter 26 may be positioned between the electric machine 20 and the gear box 28. The torque converter 26 may provide torque multiplication during launch events. The torque converter 26 may also perform torsional isolation to the driveline such that the driveline is isolated from disturbances.

A controller 40 may be configured to operate the vehicle 10 or powertrain 12 in a plurality of modes. The controller may operate the vehicle 10 in a charge depletion mode in which the engine 14 may be isolated from the remainder of the powertrain 12 via the disconnect clutch 18. In the charge depletion mode, the electric machine 20 may act as the sole drive source for the vehicle 10 using the traction battery 22 as its power source. The controller 40 may operate the vehicle 10 in a charge sustaining mode in which the engine 14 is operatively connected to the remainder of the powertrain 12 via the disconnect clutch 18. In the charge sustaining mode, the engine 14 and electric machine 20 may act as drive sources for the vehicle 10.

The controller 40 may be configured to operate the vehicle 10 or powertrain 12 in a power generation mode in which electric power is supplied to a device 50. The device 50 may be a device external to the vehicle 10, such as a power tool, a saw, a drill, a welding device, or other device requesting power. In order to provide power to the device 50, the vehicle 10 may include a power converter 52. The power converter 52 may be integrated into the traction battery 22 or provided as a separate component as shown in FIG. 1.

The power converter 52 may be a step-down or step-up converter or transformer. In at least one embodiment, the power converter may be a step down converter configured to receive high-voltage AC power from the electric machine 20 or high voltage DC power from the traction battery 22, and provide reduced AC power to the power point 54. In at least one embodiment, the power converter 52 may include an AC transformer to reduce the voltage and a rectifier to convert from AC to DC, and provide reduced DC power to the power point 54.

The power point 54 may include a current sensor and/or a voltage sensor. The sensors may be configured to measure the current and/or voltage provided to the device 50 external to the vehicle 10 connected to the power point 54.

The power point 54 may include a connector 56. The connector 56 may be a grounded receptacle or ungrounded receptacle. The receptacle may be similar to a NEMA type 5 or NEMA type 1 receptacle. In at least one embodiment, the connector 56 may be similar to a NEMA type 14 or a JIS C 8303 receptacle. In at least one embodiment, the connector 56 may be a grounded plug or ungrounded plug.

Certain enablement basics may be met prior to the controller 40 operating the vehicle 10 or powertrain 12 in power generation mode. These enablement basics may include the transmission 16 being in a state in which no torque may be transmitted to the vehicle wheels and the vehicle ignition being in an “on” position.

No torque may be transmitted to the vehicle wheels when the transmission 16 is in “park” or “neutral”. “Park” may be a transmission state in which the transmission 16 is inhibited from providing output torque to the vehicle wheels by the engagement of a parking pawl or the like to restrict rotation of the output shaft 30. “Neutral” may be a transmission state where the rotation of the output shaft 30 is not restricted, but the vehicle wheels are restricted from rotating by the application of a parking brake or an emergency brake.

In response to the controller 40 detecting or determining that the transmission is in “park” or “neutral” with the parking brake activated and the ignition in an “on” position, the operator of the vehicle 10 may be permitted to select power generation mode via a user interface 60. In at least one embodiment, a switch may be disposed proximate the power point 54 to enable the operator of the vehicle 10 to activate the power point 54 if the enablement basics are met. In response to the activation of the power generation mode, the traction battery 22 may provide power to the device 50 external to the vehicle.

While illustrated as one controller, the controller 40 may be part of a larger control system and may be controlled by various other controllers throughout the vehicle 10, such as a vehicle system controller (VSC). It should therefore be understood that the controller 40 and one or more other controllers may collectively be referred to as a “controller” that controls various actuators in response to signals from various sensors to control functions such as starting/stopping the engine 14, operating electric machine 20 to provide wheel torque or charge the traction battery 22, monitoring the state of charge of the traction battery 22, selecting or scheduling transmission shifts, providing power to the power point 54, etc.

The controller 40 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 40 in controlling the powertrain 12 or vehicle 10.

The controller 40 may be in communication with sensors disposed within or proximate the traction battery 22 to monitor the state of charge of the traction battery 22. As the traction battery 22 is powering the device 50 external to the vehicle while the engine 14 is off, the state of charge of the traction battery 22 may reduce. This reduction in the state of charge may require that the engine 14 and the electric machine 20 be operated to charge the traction battery 22.

In response to the state of charge of the traction battery 22 approaching or being less than a traction battery state of charge lower threshold, while the traction battery 22 is providing power to the device 50, the controller 40 may output an engine start request. The engine start request may include a command to the disconnect clutch 18 to couple the engine 14 with the electric machine 20. The engine start request may also include a command that a predetermined amount of traction battery power be provided to the electric machine 20. The predetermined amount of traction battery power may be based on the power capabilities of the traction battery 22. The power capabilities of the traction battery 22 may vary based on ambient temperature or traction battery temperature.

The power may be provided to the electric machine 20 to rotate the electric machine 20 and the engine 14 up to a desired speed. Upon the engine 14 reaching a desired engine cranking speed, the engine 14 may be fueled and started. The engine 14 may begin producing torque which may spin the electric machine 20 and produce power to charge the traction battery 22.

The controller 40 may be programmed to operate the engine 14 and the electric machine 20 to provide power to the traction battery 22 at a rate, according to a non-aggressive charging profile or an aggressive charging profile. While operating the powertrain 12 according to the non-aggressive charging profile, the controller 40 may operate the engine 14 and the electric machine 20 to provide power to the traction battery based on an electric power load requested by the device 50 external to the vehicle 10.

The engine 14 may be operated at an idle speed by default. The electric machine 20 by virtue of the coupling to the engine 14 may provide a first power level to the traction battery 22. In response to an increase in the power load requested by the device 50, the engine speed and/or engine torque may be increased such that the electric machine 20 provides a second power level, greater than the first power level, to the traction battery 22. In response to a decrease in the power load requested by the device 50, the engine speed may be decreased such that the electric machine 20 provides a third power level, less than the second power level. The engine speed and engine power level, and ultimately the electric machine power output, may be based on the electric power load requested by the device 50 while the controller 40 is operating the powertrain 12 according to the non-aggressive charging profile.

The non-aggressive charging profile may negatively affect the engine speed and the fuel economy of the engine 14. The engine 14 typically has a low efficiency at idle speed. The engine 14 may be held at inefficient operating points as the engine speed is varied, which may decrease the overall system efficiency. In an attempt to improve fuel economy and overall system efficiency, the controller 40 may be programmed to operate the engine 14 and the electric machine 20 to charge the traction battery 22 at a rate based on an aggressive charging profile in response to the state of charge of the traction battery 22 approaching or being less than a lower threshold.

The aggressive charging profile may operate the engine 14 at a predetermined power level. The engine 14 and electric machine 20 may be run at optimal operating points to maximize system efficiency for the predetermined power level. The predetermined power level may remain fairly constant irrespective of an electric power load requested by the device 50 while the traction battery 22 is providing power to the device 50.

The predetermined power level may be an engine power level that minimizes engine fuel consumption while maximizing power delivery by the electric machine 20 to the traction battery 22. The predetermined power level may be a power level that may be sufficient to satisfy a maximum available power output that may be provided to the device 50 and to charge the traction battery 22 at a predetermined rate.

The controller 40 may calculate the predetermined power level of the engine 14 and operating point of the electric machine 20 based on a fuel consumption map and/or an electric machine efficiency map. The fuel consumption map may be a multi-dimensional map that may enable the controller 40 to select an engine speed and an engine torque to obtain the lowest engine fuel consumption and a corresponding engine power level that may satisfy the maximum available power output and charge the traction battery 22 at the rate.

The electric machine efficiency map may be a multi-dimensional map that may enable the controller 40 to select a desired electric machine torque. The controller 40 may correlate an electric machine rotational speed to an electric machine output torque. The electric machine output torque and electric machine output power may remain steady or begin to decrease above a predetermined electric machine speed, referred to as a motor torque knee point. The controller 40 may inhibit the engine speed and engine torque from being applied to the electric machine 20 such that the motor torque knee point may not be reached, ensuring efficient electric machine operation.

The controller 40 may adjust the predetermined power level and/or the rate at which the traction battery 22 is charged based on an engine speed, an electric machine speed, an ambient temperature, a traction battery condition, or an electric machine condition. The controller 40 may reduce the predetermined power level by reducing at least one of the engine speed and the engine torque, in response to an engine speed that may rotate the electric machine at a speed greater than the motor torque knee point.

The controller 40 may adjust the predetermined power level and/or the rate at which the traction battery 22 is charged based on an ambient temperature. A temperature sensor may be disposed within the vehicle cabin or disposed proximate the exterior of the vehicle 10 and configured to measure or monitor the ambient temperature. The controller 40 may reduce the predetermined power level and reduce the rate as the ambient temperature increases.

As the ambient temperature increases, the electric machine temperature may increase and approach electric machine thermal constraints or thermal limits. A temperature sensor may be disposed proximate the electric machine 20 and may be configured to measure or monitor electric machine winding temperature, electric machine oil temperature, or other electric machine component temperatures.

The increase in the electric machine temperature may reduce the rated power of the electric machine 20. The rated power of the electric machine 20 may be due to the elevated temperatures degrading the winding insulation, degrading the state of magnetization of the permanent magnets, approaching a bearing temperature limit, or approaching the cooling capability limits of the electric machine 20. In response to an electric machine temperature approaching an electric machine temperature upper threshold, the controller 40 may reduce at least one of the engine speed, the engine torque, the electric machine speed, and the electric machine torque to avoid approaching the electric machine thermal constraints or limits.

As the ambient temperature increases, the traction battery temperature may increase. A temperature sensor may be disposed proximate the traction battery 22 and be configured to monitor or measure a temperature of at least one traction battery cell. As the traction battery temperature increases, battery performance may deteriorate and decrease the ability of the traction battery 22 to accept an electrical charge or power from the electric machine 20. In response to a traction battery temperature approaching a traction battery temperature upper threshold, the controller 40 may reduce at least one of the engine speed, the engine torque, the electric machine speed, and the electric machine torque.

The controller 40 may decrease the predetermined power level and/or the rate based on the traction battery condition. The traction battery condition may include the traction battery temperature or the state of charge of the traction battery 22. In response to the state of charge of the traction battery 22 approaching a state of charge upper threshold, while the traction battery 22 is providing power to the device 50, the controller 40 may reduce the rate at which power is provided to the traction battery 22.

In response to the state of charge of the traction battery 22 approaching a state of charge lower threshold, while the traction battery 22 is providing power to the device 50 and the traction battery 22 is receiving power from the electric machine 20, the controller 40 may increase the rate at which power is provided to the traction battery 22. The controller 40 may increase at least one of the engine speed, the engine torque, the electric machine speed, and the electric machine torque to increase the rate.

The traction battery 22 may also be limited in the amount of power it is able to receive within a predetermined period of time. The controller 40 may decrease the predetermined power level and/or the rate if the rate is approaching or is greater than the amount of power the traction battery 22 it is able to receive within the predetermined time period. The controller 40 may reduce at least one of the engine speed, the engine torque, the electric machine speed, and the electric machine torque.

The controller 40 may decrease the predetermined power level and/or the rate based on the electric machine condition. The electric machine condition may include an electric machine component temperature, an electric machine state of magnetism, and an electric machine maximum power output. As the electric machine temperature approaches or exceeds the electric machine temperature upper threshold, the electric machine state of magnetism may decrease. As the electric machine power output approaches or exceeds the electric machine power output threshold, the controller 40 may decrease the predetermined power level and/or the rate. The controller 40 may decrease the rate by decreasing at least one of the engine speed, the engine torque, the electric machine speed, and the electric machine torque.

The controller 40 may continue to operate the engine 14 and the electric machine 20 to provide power to the traction battery 22 at least until the traction battery state of charge approaches or achieves the upper threshold. In response to the traction battery state of charge being greater than the upper threshold, the controller 40 may command an engine stop. The controller 40 may also stop operating the engine 14 and the electric machine 20 to provide power to the traction battery 22 while the traction battery 22 continues providing power to the device 50.

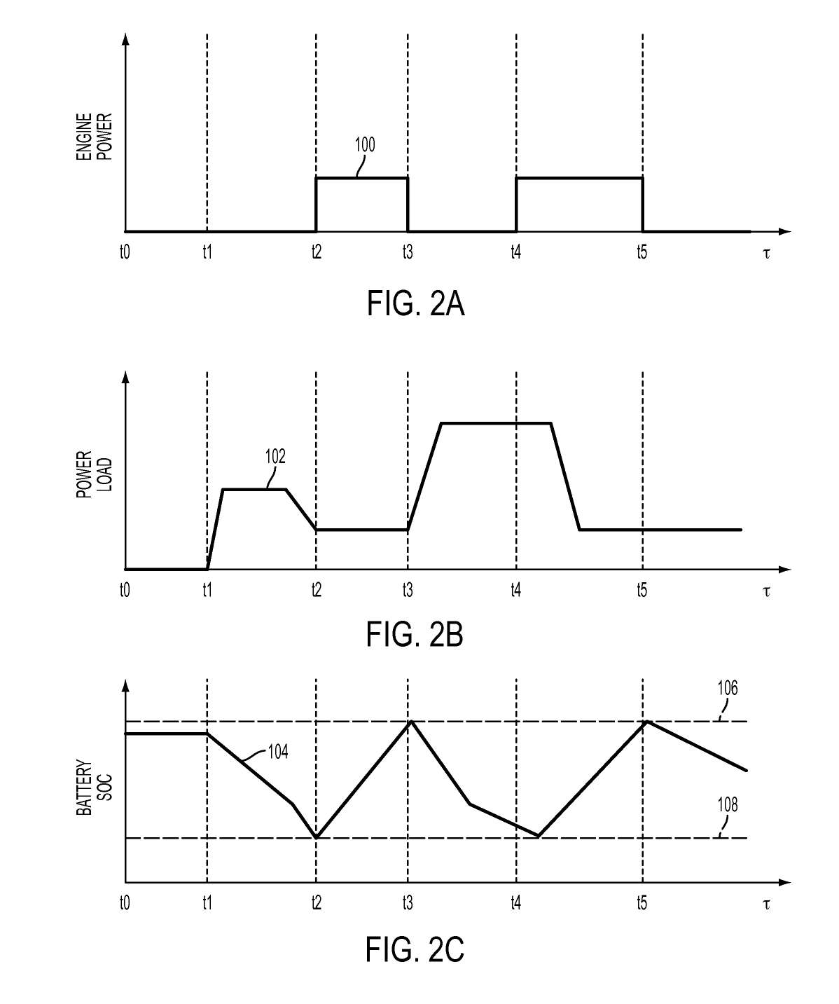

FIGS. 2A through 2C depict corresponding time plots of engine power, power load requested by the device external to the vehicle, and the traction battery state of charge, respectively. The plots may correspond in time and demonstrate an exemplary embodiment of power generation mode optimization.

FIG. 2A is a plot of engine power, specifically the predetermined engine power level 100 over time. Proximate time t0 and time t1, the engine 14 may be off and not producing power.

FIG. 2B is a plot of the power load 102 requested by the device 50 external to the vehicle 10. At time t0 the device 50 external to the vehicle 10 is not requesting power from the traction battery 22. Proximate time t1, the device 50 may request a power load that increases to a first level proximate time t1 and remain steady until proximate time t2.

FIG. 2C is a plot of the traction battery state of charge 104. At time t0 the traction battery state of charge 104 may be proximate the state of charge upper threshold 106. As the device 50 external to the vehicle 10 requests a power load from the traction battery 22, proximate time t1, the traction battery state of charge 104 may begin to decrease. Proximate time t2, the traction battery state of charge 104 may approach the state of charge lower threshold 108.

Referring to FIGS. 2A-2C, in response to the traction battery state of charge 104 approaching the state of charge lower threshold 108 proximate t2, the controller 40 may command an engine start. Proximate time t2 the engine 14 may begin producing power at a predetermined power level. The predetermined power level may remain constant regardless of the change in the power load 102 to a second power level less than the first power level, proximate time t2 and time t3.

The engine 14 and the electric machine 20 may be operated to provide power to the traction battery 22 at a rate to charge the traction battery 22 proximate time t2. In response to the traction battery state of charge 104 approaching the state of charge upper threshold 106, proximate time t3, the controller 40 may command an engine stop. The engine stop may be commanded despite the change in the power load 102 requested by the device 50, proximate time t3.

The engine 14 may remain off as the power load 102 increases to a third level, greater than the first power level, proximate time t3. In response to the traction battery state of charge 104 approaching the state of charge lower threshold, proximate time t4, the controller 40 may command an engine start. Proximate time t4 the engine 14 may begin producing power at a predetermined power level. The predetermined power level may remain constant regardless of the reduction in the power load 102 to a fourth power level, less than the first power level, proximate time t5.

The engine 14 and the electric machine 20 may be operated to provide power to the traction battery 22 at a rate to charge the traction battery 22 proximate time t4. In response to the traction battery state of charge 104 approaching the state of charge upper threshold 106 proximate time t5, the controller 40 may command an engine 14 stop. The engine stop may be commanded regardless of the change in the power load 102 requested by the device 50, proximate time t4.

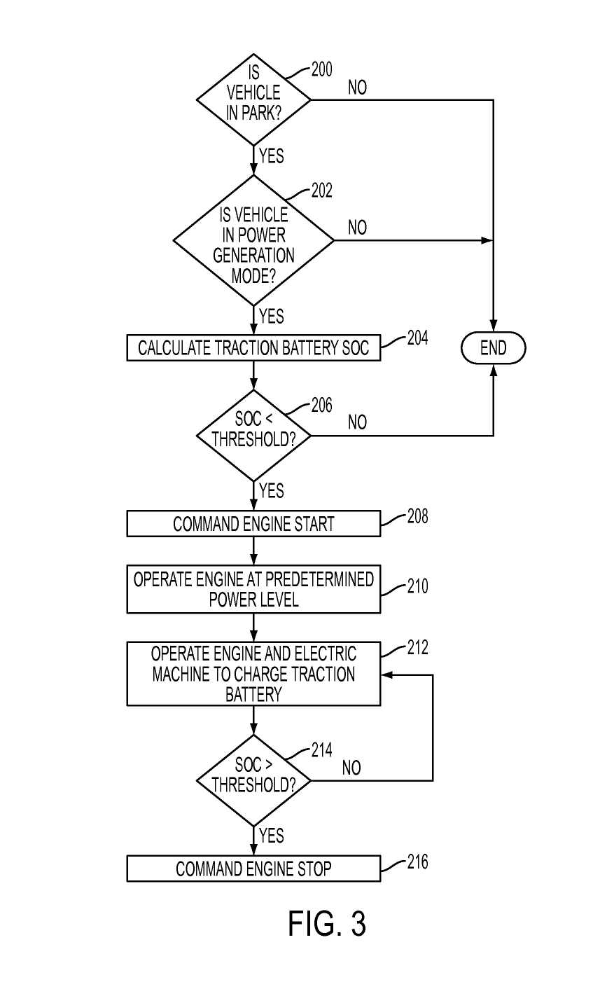

Referring to FIG. 3, a flowchart of an exemplary method of controlling the vehicle 10 is shown. The method may be executed by the controller 40 and may be implemented as a closed loop control system. For brevity, the method will be described in the context of a single iteration below.

The control logic may monitor the ignition state, the transmission state, and the power generation mode state. At block 200, the method may determine whether the vehicle 10 or the transmission 16 is in a “park” or “neutral” state with the parking brake applied. If the vehicle 10 or the transmission 16 is not in a “park” or “neutral” state with the parking brake applied, the method may end. Should the vehicle 10 or the transmission 16 be in a “park” or “neutral” state with the parking brake applied, the method may continue to block 202.

At block 202, the method may determine whether the operator of the vehicle 10 has activated the power generation mode. If the operator of the vehicle 10 has not activated the power generation mode, the method may end. Should the operator of the vehicle 10 activate the power generation mode, the method may continue to block 204.

At block 204, the method may determine or calculate the traction battery 22 state of charge. At block 206, if the traction battery state of charge is greater than a traction battery state of charge lower threshold, the method may command the traction battery 22 to provide power to the device 50 external to the vehicle 10 with the engine 14 off and the method may end. Should the traction battery 22 state of charge be less than or approaching a traction battery state of charge lower threshold, the method may continue to block 208.

At block 208, the method may command an engine start. The method may calculate a predetermined engine power level based on a combination of at least two of an engine speed, an engine torque, an electric machine speed, an estimated engine fuel consumption, an electric machine torque, an ambient temperature, an electric machine temperature, a traction battery temperature, or an electric machine power limit. At block 210, the engine 14 may be operated at the predetermined engine power level irrespective of an electric load requested by the device 50 external to the vehicle 10.

At block 212, the engine 14 and the electric machine 20 may be operated to provide power to the traction battery 22 to charge the traction battery 22 at a rate. The rate at which the traction battery 22 is charged may be based on at least one of a current traction battery state of charge, an electric machine speed, an electric machine temperature, a traction battery temperature, an engine speed, an engine torque, or a fuel consumption rate. In response to at least one of an electric machine temperature or a traction battery temperature approaching an upper threshold, the rate may be reduced.

At block 214, if the traction battery state of charge is less than a traction battery state of charge upper threshold, the method may continue to operate the engine 14 and the electric machine 20 to charge the traction battery 22 at the rate, at block 212. Should the traction battery state of charge be greater than or approaching the traction battery state of charge upper threshold, the method may continue to block 216, in which the controller 40 may command an engine stop.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
a powertrain including an electric machine and engine;
a traction battery; and
a controller programmed to, in response to a state of charge of the traction battery being less than a threshold while the traction battery is powering a device external to the vehicle, operate the powertrain to charge the traction battery at a rate based on an ambient temperature irrespective of a power load requested by the device.

2. The vehicle of claim 1 wherein the rate decreases as the ambient temperature increases.

3. The vehicle of claim 1 wherein the rate is further based on a fuel consumption rate and speed of the engine.

4. The vehicle of claim 1 wherein the rate is further based on a traction battery temperature.

5. The vehicle of claim 1 wherein the controller is further programmed to reduce the rate based on a temperature of the traction battery.

6. The vehicle of claim 1 wherein the controller is further programmed to reduce the rate based on a speed of the electric machine.

7. The vehicle of claim 1 wherein the controller is further programmed to, in response to the state of charge approaching an upper threshold, reduce the rate.

8. A vehicle comprising:
an engine;
a traction battery; and
a controller programmed to, in response to a state of charge of the traction battery approaching a lower threshold while the traction battery is powering a device external to the vehicle, operate the engine to charge the traction battery at a predetermined power level that is based on a fuel consumption rate and speed of the engine.

9. The vehicle of claim 8 wherein the predetermined power level is further based on a temperature of the traction battery.

10. The vehicle of claim 8 further comprising an electric machine, wherein the predetermined power level is further based on a temperature of the electric machine.

11. The vehicle of claim 8 wherein the predetermined power level is further based on an ambient temperature.

12. The vehicle of claim 8 wherein the predetermined power level is further based on a power load requested by the device external to the vehicle.

13. A method of controlling a vehicle:
in response to a state of charge of a traction battery approaching a lower threshold while the traction battery provides power to an off-board auxiliary device, operating an engine and an electric machine to charge the traction battery at a rate based on the state of charge, a speed of the electric machine, and a temperature of the traction battery.

14. The method of claim 13 wherein the rate is further based on an electric machine temperature.

15. The method of claim 13 wherein the rate is further based on a speed, torque and fuel consumption rate of the engine.

16. The method of claim 13 further comprising, in response to an electric machine temperature or a temperature of the traction battery approaching a threshold, reducing the rate.

17. The method of claim 13 wherein the engine is operated at a predetermined power level irrespective of an electric load requested by the off-board auxiliary device.

18. The method of claim 17 wherein the predetermined power level is based on an electric machine temperature, a temperature of the traction battery, and a power limit of the electric machine.
